(19) United States
(12) Patent Application Publication
(10) Pub. No.: US 2020/0366030 A1
(43) Pub. Date: Nov. 19, 2020

(54) INTERLOCK SYSTEM

(71) Applicant: ISUZU MOTORS LIMITED, Tokyo (JP)

(72) Inventors: Keihin GO, Fujisawa-shi, Kanagawa (JP); Mitsuhiro ASO, Fujisawa-shi, Kanagawa (JP)

(21) Appl. No.: 16/959,970

(22) PCT Filed: Dec. 25, 2018
(86) PCT No.: PCT/JP2018/047583

§ 371 Date: Jul. 2, 2020

(30) Foreign Application Priority Data
Jan. 4, 2018 (JP) 2018-000047

(51) Int. Cl. H01R 13/641; H01R 13/44

(52) U.S. Cl. CPC H01R 13/641; H01R 13/44

(57) ABSTRACT

An interlock system 50, provided with: a set of interlock terminals 51a, 51b disposed on a first connector 20; an interlock terminal connection part 52; a DC power supply 53; an interlock wiring 54 routed so that a set of interlock terminals of a plurality of first connectors are serially connected with respect to the DC power supply, in a state in which electricity can be conducted between the set of interlock terminals; a current cutoff detection unit 57 for detecting an interruption to the flow of electricity from the DC power supply to the interlock wiring; and a current cutoff control unit 58 for cutting off the flow of electricity between a power supply 10 and connector terminals 22a, 22b when an interruption to the flow of electricity from the DC power supply to the interlock wiring is detected.

### TECHNICAL FIELD

The present disclosure relates to an interlock system, and particularly to an interlock system applied to a vehicle including a plurality of connectors each having a connector terminal connected to a power supply.

### BACKGROUND ART

In the related art, a vehicle including a connector having a connector terminal connected to a power supply is known. In such a vehicle, in order to ensure the safety “at the time of detachment of a connector”, that is, at the time when a second connector attached to this connector is detached from this connector, an interlock system that cuts off a flow of electricity between the power supply and the connector terminal when the connector is detached has been developed (for example, see Patent Literature 1).

### CITATION LIST

### Patent Literature

Patent Literature 1: JP-A-2013-098056

### SUMMARY OF INVENTION

### Technical Problem

In recent years, a vehicle having a plurality of connectors has been developed. Therefore, in such a vehicle, in order to ensure the safety at the time of detachment of the connector, it is conceivable to devise an interlock system that cuts off the flow of electricity between a power supply and a connector terminal in a case where current cut-off detection units detecting that electricity has stopped flowing into an interlock wiring at the time of detachment of the connector are disposed for respective connectors, and at least one current cut-off detection unit of the plurality of current cut-off detection units detects that electricity has stopped flowing into the interlock wiring, for example. However, in the case of such an interlock system, since the current cut-off detection units are provided for the respective connectors, a configuration of the interlock system becomes complicated.

The present disclosure has been made in view of the above circumstances, and an object thereof is to provide an interlock system capable of simplifying the configuration.

### Solution to Problem

In order to achieve the above object, an interlock system according to an aspect of the present disclosure which is applied to a vehicle including a plurality of first connectors each having a connector terminal connected to a power supply includes: a pair of interlock terminals disposed on the first connector; an interlock terminal connection part disposed on a second connector that is attached to or detached from the first connector, the interlock terminal connection part being configured to enable electricity to be conducted between the pair of interlock terminals by being connected to the pair of interlock terminals when the second connector is attached to the first connector, the interlock terminal connection part being configured to disable electricity to be conducted between the pair of interlock terminals by being separated from the pair of interlock terminals when the second connector is detached from the first connector, a DC power supply; an interlock wiring wired such that, in a state where electricity is enabled to be conducted between the pair of interlock terminals, each pair of interlock terminals of the plurality of first connectors is connected in series to the DC power supply; a current cut-off detection unit configured to detect that electricity from the DC power supply has stopped flowing into the interlock wiring; and a current cut-off control unit configured to cut off a flow of electricity between the power supply and the connector terminal when the current cut-off detection unit detects that electricity from the DC power supply has stopped flowing into the interlock wiring.

### Advantageous Effects of Invention

According to the aspect of the present disclosure, since each pair of interlock terminals of the plurality of first connectors is connected in series to the DC power supply via the interlock wiring, it is possible to detect that electricity has stopped flowing into the interlock wiring by using one current cut-off detection unit. Accordingly, the configuration of the interlock system can be simplified.

### BRIEF DESCRIPTION OF DRAWINGS

FIG. 1 is a configuration diagram schematically showing a configuration of a vehicle according to a first embodiment.

FIG. 2A is a schematic cross-sectional view for describing a first connector and a second connector in detail.

FIG. 2B is a schematic cross-sectional view for describing the first connector and the second connector in detail.

FIG. 3 is a configuration diagram schematically showing a configuration of a vehicle according to a second embodiment.

FIG. 4A is a schematic cross-sectional view for describing a connector cap.

FIG. 4B is a schematic cross-sectional view for describing the connector cap.

### DESCRIPTION OF EMBODIMENTS

### First Embodiment

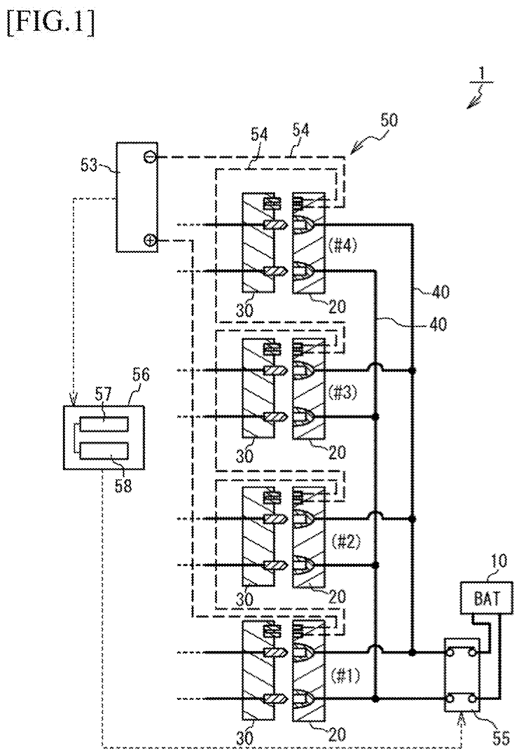

FIG. 1 is a configuration diagram schematically showing a configuration of a vehicle 1 to which an interlock system 50 according to the first embodiment of the present disclosure is applied. FIG. 1 schematically shows an example of a state in which second connectors 30 are detached from first connectors 20 in a case where the second connectors 30 are attached to all of the plurality of first connectors 20 (that is, in a case where all of the first connectors 20 are used).

The vehicle 1 illustrated in FIG. 1 includes a power supply 10, the plurality of first connectors 20, the plurality of second connectors 30, a connector wiring 40, and the interlock system 50. In the present embodiment, a truck is used as an example of the vehicle 1. Further, the vehicle 1 according to the present embodiment is a hybrid vehicle including an engine and a traveling motor as a traveling drive source. However, the configuration of the vehicle 1 is not limited thereto, and for example, the vehicle 1 may be a normal vehicle including only an engine as the traveling drive source, or an electric vehicle including only a traveling motor.

The power supply 10 is mounted on a vehicle body of the vehicle 1 (specifically, a portion other than amounted portion of the vehicle 1). In the present embodiment, for example, a battery such as a lithium ion battery or a nickel hydrogen battery is used as the power supply 10. A rated voltage of the power supply 10 is not particularly limited, and 300 V is used as an example in the present embodiment.

Each first connector 20 is electrically connected to the power supply 10 via the connector wiring 40. The second connector 30 is a connector attached to or detached from the first connector 20.

As an example, the first connector 20 according to the present embodiment is a connector disposed in the vehicle body of the vehicle 1, and the second connector 30 is a connector disposed in a mounted portion (a mounted portion of the truck) of the vehicle 1. That is, the second connector 30 according to the present embodiment is a connector for the mounted portion.

However, the specific type of the second connector 30 is not limited thereto. As another example, for example, the second connector 30 may be a connector of an inverter of the vehicle 1, or may be a connector of a DC-DC converter of the vehicle 1. Alternatively, some second connector 30 out of the second connectors 30 of #1 to #4 may be a connector of the mounted portion, some second connector 30 may be a connector of an inverter of the vehicle 1, and the other second connectors 30 may be connectors of the DC-DC converter of the vehicle 1.

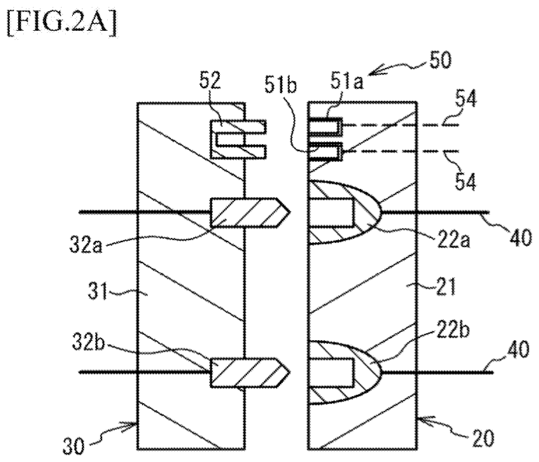

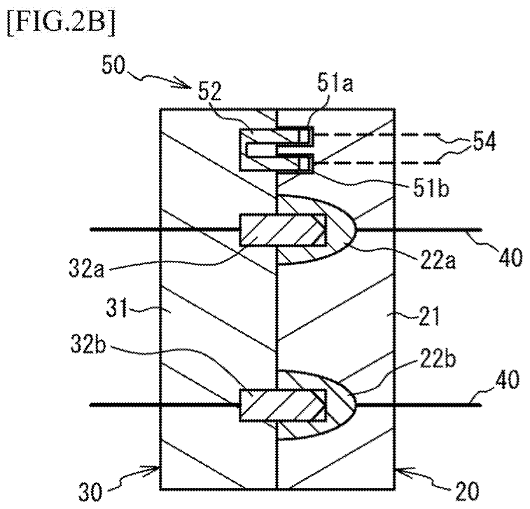

FIGS. 2A and 2B are schematic cross-sectional views for describing the first connector 20 and the second connector 30 in detail. Specifically, FIG. 2A is a schematic cross-sectional view showing a state where the second connector 30 is detached from the first connector 20, and FIG. 2B is a schematic cross-sectional view showing a state where the second connector 30 is attached to the first connector 20.

The first connector 20 includes: a connector body 21; and a first connector terminal 22a and a first connector terminal 22b which are disposed on the connector body 21. The second connector 30 includes: a connector body 31; and a second connector terminal 32a and a second connector terminal 32b which are disposed on the connector body 31. In the present embodiment, as an example, the first connector terminals 22a, 22b are female terminals, and the second connector terminals 32a, 32b are male terminals. However, the present disclosure is not limited to this configuration, and for example, the first connector terminals 22a, 22b may be male terminals, and the second connector terminals 32a, 32b may be female terminals.

The connector body 21 is electrically insulated from the first connector terminals 22a, 22b. Similarly, the connector body 31 is electrically insulated from the second connector terminals 32a, 32b.

As shown in FIG. 2A, when the second connector 30 is detached from the first connector 20, the first connector terminals 22a, 22b and the second connector terminals 32a, 32b are not connected. On the other hand, as shown in FIG. 2B, when the second connector 30 is attached to the first connector 20, the second connector terminals 32a, 32b are connected to the first connector terminals 22a, 22b, whereby the first connector terminals 22a, 22b and the second connector terminals 32a, 32b are electrically connected. In this case, electricity flowing from the power supply 10 to the first connector terminals 22a, 22b flows to the second connector terminals 32a, 32b.

Next, the interlock system 50 will be described with reference to FIGS. 1 and 2. As shown in FIG. 2A, the interlock system 50 includes: a pair of interlock terminals 51a, 51b disposed on the connector body 21 of the first connector 20; and an interlock terminal connection part 52 disposed on the connector body 31 of the second connector 30. As shown in FIG. 1, the interlock system 50 further includes: a DC power supply 53, an interlock wiring 54 (shown by a broken line so as to be easily visible in FIG. 1); a relay 55; and a controller 56. The DC power supply 53, the interlock wiring 54, the relay 55, and the controller 56 are mounted to the vehicle body of the vehicle 1.

As shown in FIG. 2A, the interlock terminals 51a, 51b and the connector body 21 are electrically insulated from each other. Similarly, the interlock terminal connection part 52 and the connector body 31 are electrically insulated from each other.

Since the interlock terminal connection part 52 is disposed on the second connector 30, the interlock terminal connection part 52 moves integrally with the second connector 30. The interlock terminal connection part 52 has conductivity.

As an example, the interlock terminal connection part 52 according to the present embodiment has a substantially U-shaped external shape, and one end and the other end of the interlock terminal connection part 52 protrude outward from a surface of the connector body 31.

As shown in FIG. 2B, when the second connector 30 is attached to the first connector 20, the one end of the interlock terminal connecting portion 52 is inserted into the interlock terminal 51a, and the other end of the interlock terminal connection part 52 is inserted into the interlock terminal 51b (that is, the interlock terminal connection part 52 is connected to the pair of interlock terminals 51a, 51b). Accordingly, the interlock terminal 51a and the interlock terminal 51b are connected to each other via the interlock terminal connection part 52. As a result, a state where electricity can flow between the interlock terminal 51a and the interlock terminal SI b is obtained (that is, electricity can be conducted between the pair of interlock terminals). As a result, electricity from the DC power supply 53 flows into the interlock wiring 54 to be described later.

On the other hand, as shown in FIG. 2A, when the second connector 30 is detached from the first connector 20, the interlock terminal connection part 52 is separated from the interlock terminals 51a, 51b and is not connected to the interlock terminals 51a, 51b. In this case, the interlock terminal 51a and the interlock terminal 51b are not connected to each other, and a state where electricity cannot flow between the interlock terminal 51a and the interlock terminal 51b is obtained (that is, electricity cannot be conducted between the pair of interlock terminals). As a result, electricity from the DC power supply 53 does not flow into the interlock wiring 54 to be described later.

That is, when the second connector 30 is attached to the first connector 20, the interlock terminal connection part 52 according to the present embodiment is connected to the pair of interlock terminals 51a, 51b, so that electricity can be conducted between the pair of interlock terminals 51a, 51b (FIG. 2B). When the second connector 30 is detached from the first connector 20, the interlock terminal connection part 52 is separated from the pair of interlock terminals 51a, 51 b, so that electricity cannot be conducted between the pair of interlock terminals 51a, 51b (FIG. 2A).

Referring to FIG. 1, the DC power supply 53 is a DC power supply for causing electricity to flow into the interlock wiring 54. The DC power supply 53 causes electricity to flow into the interlock wiring 54 at a predetermined voltage. A specific example of the voltage of the DC power supply 53 is not particularly limited, and for example, about 5 V can be used.

In a state where electricity can be conducted between the pair of interlock terminals 51a, 51b, the interlock wiring 54 is wired such that each pair of interlock terminals 51a, 51b of the plurality of first connectors 20 are connected in series to the DC power supply 53.

Specifically, when all of the second connectors 30 are attached to the first connectors 20 in FIG. 1, the interlock terminals 51a, 51b of the respective first connectors 20 are connected to each other via the interlock terminal connection parts 52 of the corresponding second connectors 30, and are in a state where electricity can be conducted between the interlock terminals 51a, 51b of the respective first connectors 20. In this case, electricity supplied from the DC power supply 53 flows through the interlock terminal 51a of the first connector 20 of #1 in FIG. 1, the interlock terminal 51b of this connector, the interlock terminal 51a of the first connector 20 of #2, the interlock terminal 51b of this connector, the interlock terminal 51a of the first connector 20 of #3, the interlock terminal 51b of this connector, the interlock terminal 51a of the first connector 20 of #4, and the interlock terminal 51b of this connector in this order, and returns to the DC power supply 53.

The relay 55 is disposed in a portion of the connector wiring 40 between the power supply 10 and the first connector terminals 22a, 22b. The relay 55 is a device for switching between a state where the power supply 10 and the first connector terminals 22a, 22b are electrically connected and a state where the power supply 10 and the first connector terminals 22a, 22b are electrically cut off in response to an instruction from the controller 56.

Specifically, the relay 55 normally keeps the power supply 10 and the first connector terminals 22a, 22b electrically connected such that electricity from the power supply 10 flows to the first connector terminals 22a, 22b via the connector wiring 40. On the other hand, when the relay 55 receives a current cut-off command from a current cut-off control unit 58, which will be described later, of the controller 56, the relay 55 cuts off the flow of electricity between the power supply 10 and the first connector terminals 22a, 22b by electrically cutting off the power supply 10 and the first connector terminals 22a, 22b.

The controller 56 is a control device that controls the operation of the interlock system 50. When viewed from the viewpoint of hardware, the controller 56 according to the present embodiment includes a microcomputer having: a CPU that executes various types of control processing; and a storage (for example, ROM, RAM, or the like) that stores various types of data, programs, and the like used for an operation of the CPU. On the other hand, when viewed from the viewpoint of function, the controller 56 includes a current cut-off detection unit 57 and the current cut-off control unit 58. The current cut-off detection unit 57 and the current cut-off control unit 58 are realized by the function of the CPU.

The current cut-off detection unit 57 detects that electricity from the DC power supply 53 has stopped flowing into the interlock wiring 54. Specifically, the DC power supply 53 according to the present embodiment sequentially detects a flow state of electricity in the interlock wiring 54, and transmits a detection result to the current cut-off detection unit 57 as a control signal. Accordingly, the current cut-off detection unit 57 sequentially detects (that is, monitors) whether electricity has stopped flowing into the interlock wiring 54 (in other words, whether electricity flows).

However, the detection method of the current cut-off detection unit 57 is not limited thereto. As another example, for example, in a case where the interlock system 50 is additionally provided with a current sensor disposed on the interlock wiring 54, the current cut-off detection unit 57 can also detect that electricity has stopped flowing into the interlock wiring 54 based on a detection result of the current sensor.

When the current cut-off detection unit 57 detects that electricity from the DC power supply 53 has stopped flowing into the interlock wiring 54, the current cut-off control unit 58 cuts off the flow of electricity between the power supply 10 and the first connector terminals 22a, 22b by applying the current cut-off command to the relay 55 (that is, by controlling the relay 55).

Next, operational effects of the interlock system 50 according to the present embodiment will be described. First, according to the present embodiment, when the second connector 30 is detached from the first connector 20, the interlock terminal connection part 52 disposed on the second connector 30 is separated from the interlock terminals 51a, 51b, so that the pair of interlock terminals 51a, 51b are not connected to each other via the interlock terminal connection part 52. Accordingly, since electricity cannot be conducted between the pair of interlock terminals 51a, 51b, electricity from the DC power supply 53 does not flow into the interlock wiring 54. When the current cut-off detection unit 57 detects that electricity has stopped flowing into the interlock wiring 54, the flow of electricity between the power supply 10 and the first connector terminals 22a, 22b is cut off by the control of the relay 55 by the current cut-off control unit 58.

As described above, according to the present embodiment, when the second connector 30 is detached from the first connector 20, the flow of electricity between the power supply 10 and the first connector terminals 22a, 22b can be cut off. Accordingly, safety at the time of detachment of the connector (safety at the time of detachment of the second connector 30 from the first connector 20) can be ensured.

Further, according to the present embodiment, since each pair of interlock terminals 51a, 51b of the plurality of first connectors 20 is connected in series to the DC power supply 53 via the interlock wiring 54, it is possible to detect that electricity from the DC power supply 53 has stopped flowing into the interlock wiring 54 by using one current cut-off detection unit 57. Accordingly, it is possible to simplify the configuration of the interlock system 50 as compared with the interlock system including the current cut-off detection unit for each connector.

That is, according to the present embodiment, it is possible to ensure the safety during detachment of the connector while simplifying the configuration of the interlock system 50.

### Second Embodiment

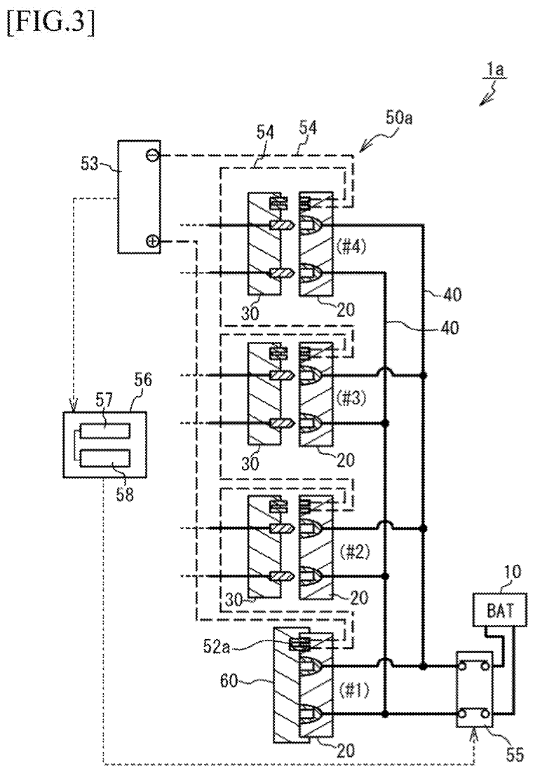

Next, an interlock system 50a according to a second embodiment of the present invention will be described. FIG. 3 is a configuration diagram schematically showing a configuration of a vehicle 1a to which the interlock system 50a according to the present embodiment is applied. Note that FIG. 3 schematically shows an example of a state where, when the second connector 30 is not attached to some of the plurality of first connectors 20 (that is, when some first connectors 20 are not used), the second connector 30 is detached from the first connectors 20 that are used. Specifically, in FIG. 3, the first connector 20 of #1 is not used, and the first connectors 20 of #2 to #4 are used.

In the interlock system 50a according to the present embodiment, instead of the second connector 30, a connector cap 60 is attached to the first connector 20 (#1) that is not used. The interlock system 50a also includes the connector cap 60 as a part of the components thereof.

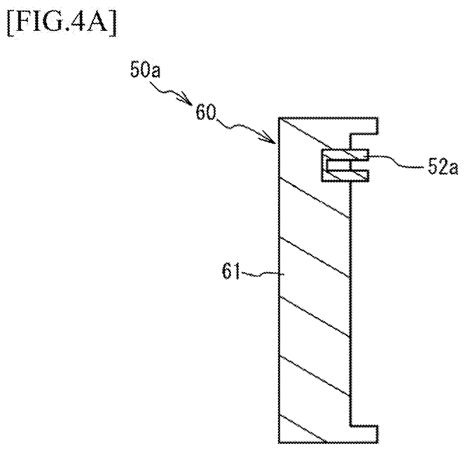

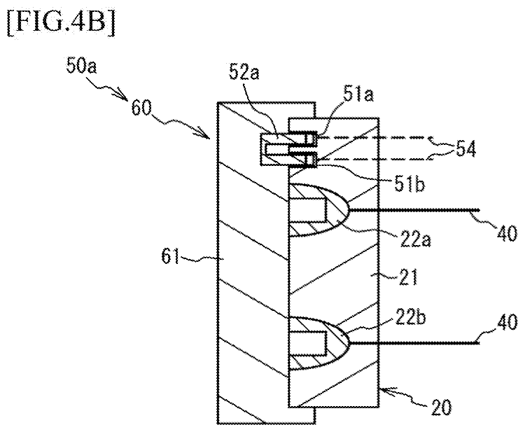

FIGS. 4A and 4B are schematic cross-sectional views for describing the connector cap 60. Specifically, FIG. 4A is a schematic cross-sectional view of the connector cap 60, and FIG. 4B is a schematic cross-sectional view showing a state where the connector cap 60 of FIG. 4A is attached to the first connector 20. The connector cap 60 differs from the second connector 30 mainly in that: the connector cap 60 includes a cap body 61 instead of the connector body 31; the connector cap 60 does not include the second connector terminals 32a, 32b; and the connector cap 60 includes a second interlock terminal connection part 52a instead of the interlock terminal connection part 52.

As shown in FIG. 4B, when the connector cap 60 is attached to the first connector 20, the cap body 61 of the connector cap 60 covers exposed portions of the first connector terminals 22a, 22b (portions exposed on an outer surface of the connector body 21). Accordingly, the first connector terminals 22a, 22b can be prevented from being exposed on the outer surface. By attaching the connector cap 60 to the first connector 20 in this manner, the connector cap 60 can protect the first connector 20 (particularly, the first connector terminal 22a, 22b).

The structure of the second interlock terminal connection part 52a is similar to that of the interlock terminal connection part 52 described above. That is, the second interlock terminal connection part 52a has conductivity. When the connector cap 60 is attached to the first connector 20, the second interlock terminal connection part 52a is connected to the pair of interlock terminals 51a, 51b, so that electricity can be conducted between the pair of interlock terminals 51a, 51b. When the connector cap 60 is detached from the first connector 20, the second interlock terminal connection part 52a is separated from the pair of interlock terminals 51a, 51b, so that electricity cannot be conducted between the pair of interlock terminals 51a, 51b.

Specifically, as shown in FIG. 48, when the connector cap 60 is attached to the first connector 20, one end of the second interlock terminal connection part 52a is inserted into the interlock terminal 51a, and the other end of the second interlock terminal connection part 52a is inserted into the interlock terminal 51b. Accordingly, the interlock terminal 51a and the interlock terminal 51b are connected to each other via the second interlock terminal connection part 52a. As a result, electricity can be conducted between the interlock terminals 51a, 51b.

In this state, when the second connectors 30 are attached to other first connectors 20 (at this time, each first connector terminal 22a, 22b of the other first connectors 20 is connected to each other via the interlock terminal connection part 52 of the second connector 30, so that electricity can be conducted therebetween), each pair of interlock terminals 51a, 51b of the plurality of first connectors 20 is connected in series with respect to the DC power supply 53. As a result, electricity from the DC power supply 53 flows through the interlock wiring 54.

On the other hand, when the connector cap 60 is detached from the first connector 20, the second interlock terminal connection part 52a is not connected to the interlock terminals 51a, 51b. As a result, electricity between the interlock terminals 51a, 51b is cut off. Accordingly, electricity from the DC power supply 53 stops flowing into the interlock wiring 54.

Although an example in which some first connectors 20 are not used is illustrated in FIG. 3, for example, when none of the plurality of first connectors 20 is used, the connector cap 60 is attached to all of the first connectors 20.

According to the present embodiment as described above, in addition to the operational effects of the first embodiment described above, the following operational effects can be achieved. Specifically, according to the present embodiment, when at least one first connector 20 is not used, the connector cap 60 is attached to the first connector 20 that is not used, so that the first connector 20 that is not used can be protected by the connector cap 60. As a result, for example, it is possible to prevent foreign matter from adhering to the first connector terminals 22a, 22b, and it is also possible to avoid a risk that the operator accidentally touches the first connector terminals 22a, 22b.

Further, since electricity can be conducted between the pair of interlock terminals 51a, 51b via the second interlock terminal connection part 52a of the connector cap 60, when the second connector 30 is attached to the other first connector 20, each pair of interlock terminals 51a, 51b of the plurality of first connectors 20 can be connected in series to the DC power supply 53. Accordingly, it is possible to detect that electricity has stopped flowing into the interlock wiring 54 by one current cut-off detection unit 57.

Therefore, for example, when the connector cap 60 is attached to the first connector 20 of #1 and the second connector 30 is attached to the other first connector 20, even if the connector cap 60 is detached from the first connector of #1 or some second connector 30 is detached from the first connectors 20 due to some factors, one current cut-off detection unit 57 can detect that electricity has stopped flowing into the interlock wiring 54 due to the detachment of the connector cap 60 or the second connector 30, and the current cut-off control unit 58 can cut off the flow of electricity between the power supply 10 and the first connector terminals 22a, 22b. Accordingly, it is possible to ensure safety during detachment of the connector cap 60 and the second connector 30 from the first connectors 20 while simplifying the configuration of the interlock system 50a.

The preferred embodiments of the present disclosure have been described above, but the present disclosure is not limited to such specific embodiments, and various modifications and changes can be made within the scope of the spirit described in the claims.

The present application is based on Japanese Patent Application No. 2018-000047 filed on Jan. 4, 2018, contents of which are incorporated herein as reference.

### INDUSTRIAL APPLICABILITY

The present disclosure is useful in that present disclosure can simplify the configuration of the interlock system and contribute to the realization of an interlock system with low cost and high reliability.

### REFERENCE SIGNS LIST

1, 1a vehicle
10 power supply
20 first connector
22a, 22b first connector terminal
30 second connector
32a, 32b second connector terminal
40 connector wiring
50, 50a interlock system
51a, 51b interlock terminal
52 interlock terminal connection part
52a second interlock terminal connection part
53 DC power supply
54 interlock wiring
55 relay
56 controller
57 current cut-off detection unit
58 current cut-off control unit
60 connector cap

1. An interlock system applied to a vehicle including a plurality of first connectors each having a connector terminal connected to a power supply, the interlock system comprising:
a pair of interlock terminals disposed on the first connector;
an interlock terminal connection part disposed on a second connector attached to or detached from the first connector, the interlock terminal connection part being configured to enable electricity to be conducted between the pair of interlock terminals by being connected to the pair of interlock terminals when the second connector is attached to the first connector, the interlock terminal connection part being configured to disable electricity to be conducted between the pair of interlock terminals by being separated from the pair of interlock terminals when the second connector is detached from the first connector;
a DC power supply;
an interlock wiring wired such that, in a state where electricity is enabled to be conducted between the pair of interlock terminals, each pair of interlock terminals of the plurality of first connectors is connected in series to the DC power supply;
a current cut-off detection unit configured to detect that electricity from the DC power supply has stopped flowing into the interlock wiring; and
a current cut-off control unit configured to cut off a flow of electricity between the power supply and the connector terminal when the current cut-off detection unit detects that electricity from the DC power supply has stopped flowing into the interlock wiring.

2. The interlock system according to claim 1, further comprising:
a connector cap attached on at least one first connector in place of the second connector when the at least one first connector is not used,
wherein the connector cap includes a second interlock terminal connection part, the second interlock terminal connection part being configured to enable electricity to be conducted between the pair of interlock terminals by being connected to the pair of interlock terminals when the connector cap is attached to the first connector, the second interlock terminal connection part being configured to disable electricity to be connected between the pair of interlock terminals by being separated from the pair of interlock terminals when the connector cap is detached from the first connector.
